(19) United States
(12) Patent Application Publication
(10) Pub. No.: US 2004/0261494 A1
(43) Pub. Date: Dec. 30, 2004

(54) Impact generating device for impact tester

(76) Inventor: Kun Ta Lee, Chong Ho City (TW)

Correspondence Address: Kun Ta LEE, P.O. Box 10-69, Chong Ho, Taipei, 235, TW

(21) Appl. No.: 10/608,794

(22) Filed: Jun. 24, 2003

(51) Int. Cl. G01N 3/00

(52) U.S. Cl. 73/12.09

(57) ABSTRACT

An impact generating device includes a base to be supported in the impact testing machine, and a hammer slidably supported above the base with one or more rods or beams and movable downwardly toward the base, for striking or impacting onto the base. One or more resilient members may be selectively coupled between the hammer and the rods or beams, to resiliently and adjustably supporting the hammer above the base, to adjustably space the hammer from the base at selected spacing distances, and to adjustably determine a moving distance of the hammer toward the base. The hammer may carry different weights by the resilient members.

### BACKGROUND OF THE INVENTION

1. Field of the Invention

The present invention relates to an impact generating device, and more particularly to an adjustable impact generating device for impact tester or impact testing machines.

2. Description of the Prior Art

Typical impact testers or impact testing machines may comprise a slidable table slidably supported above a platform, and movable downwardly toward the platform, for testing purposes, and a cushioning device disposed on the platform, to cushion the downward movement or the impact of the slidable table against the platform and/or the impact generating device.

The typical impact testers or impact testing machines may further comprise a sensing or detecting device to detect the striking or impact waves generated by the impact of the slidable table against the platform and/or the impact generating device.

For testing different materials or objects, weight members of different weights may be directly disposed or supported on the slidable table, and different striking or impact waves may be generated when the slidable table strikes or impacts against the platform and/or the impact generating device.

However, the weight members are stably disposed or supported on the slidable table, and may not generate a striking force against the slidable table and/or against the platform.

The present invention has arisen to mitigate and/or obviate the afore-described disadvantages of the conventional impact testing machines.

### SUMMARY OF THE INVENTION

The primary objective of the present invention is to provide an adjustable impact generating device for impact tester or impact testing machines, and for generating striking forces or impacts against the slidable table and/or against the platform.

In accordance with one aspect of the invention, there is provided an impact generating device for an impact testing machine, the impact generating device comprising a base to be supported in the impact testing machine, a hammer slidably supported above the base, and movable downwardly toward the base, for striking or impacting onto the base, and a resiliently and adjustably supporting device for resiliently and adjustably supporting the hammer above the base, to adjustably space the hammer from the base at selected spacing distances, and to adjustably determine a moving distance of the hammer toward the base.

One or more rods are secured to the base, and extended upwardly from the base, the hammer includes one or more apertures formed therein to slidably receive the rods, and to guide the hammer to move up and down relative to the base. One or more gaskets are further provided and engaged between the hammer and the rod, to smoothly guide the hammer to move along the rod. Each of the gaskets includes an enlarged head engaged with the hammer, to position the gasket relative to the hammer.

The resiliently and adjustably supporting device includes a bar secured on the rod, a first resilient member coupled between the hammer and the bar, and at least one second resilient member selectively coupled between the hammer and the bar. The bar includes a stop pin secured thereto, the hammer includes a stop pin secured thereto, the first and the second resilient members are selectively coupled around the stop pins of the bar and the hammer, to resiliently couple the hammer to the bar.

The rod includes a pad engaged thereon and disposed between the hammer and the bar, to prevent the hammer from striking onto the bar. The base includes an anvil swelling provided thereon, the hammer includes a hammering block extended downwardly therefrom, and arranged above the anvil swelling, to act and impact onto the anvil swelling. The hammering block of the hammer includes an inverted and frustum shape.

A spacing distance determining device may further be provided for determining the spacing distance of the hammer from the base, and includes a beam secured to the base, and extended upwardly from the base, and a first stop pin slidably engaged in the beam, and extendible out of the beam to selectively engage with the hammer, and to determine the spacing distance of the hammer from the base.

One or more second stop pins may further be provided and slidably engaged in the beam, and selectively extendible out of the beam to selectively engage with the hammer, and to selectively adjust the spacing distance of the hammer from the base.

A flap may further be provided and disposed on the hammer to selectively engage with the first stop pin and the second stop pin. The hammer includes a seat secured thereon, and having the flap extended from the seat.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of an impact tester or impact testing machine having an adjustable impact generating device in accordance with the present invention;

FIG. 2 is a perspective view of the impact tester or impact testing machine, similar to FIG. 1, illustrating the operation of the impact tester or impact testing machine;

FIG. 3 is an exploded view of the adjustable impact generating device;

FIG. 4 is a perspective view of the adjustable impact generating device;

FIGS. 5, 6, 7 are plan schematic views illustrating the operation of the adjustable impact generating device;

FIG. 8 is a plan schematic view similar to FIGS. 5-7, illustrating the adjustment operation of the adjustable impact generating device;

FIGS. 9A, 9B, 9C are plan schematic views similar to FIGS. 5-7, illustrating the operation of the adjustable impact generating device that supports a smaller object or weight; and

FIGS. 9D, 9E, 9F are plan schematic views similar to FIGS. 9A-9C, illustrating the operation of the adjustable impact generating device that supports a greater object or weight.

### DETAILED DESCRIPTION OF THE PREFERRED EMBODIMENT

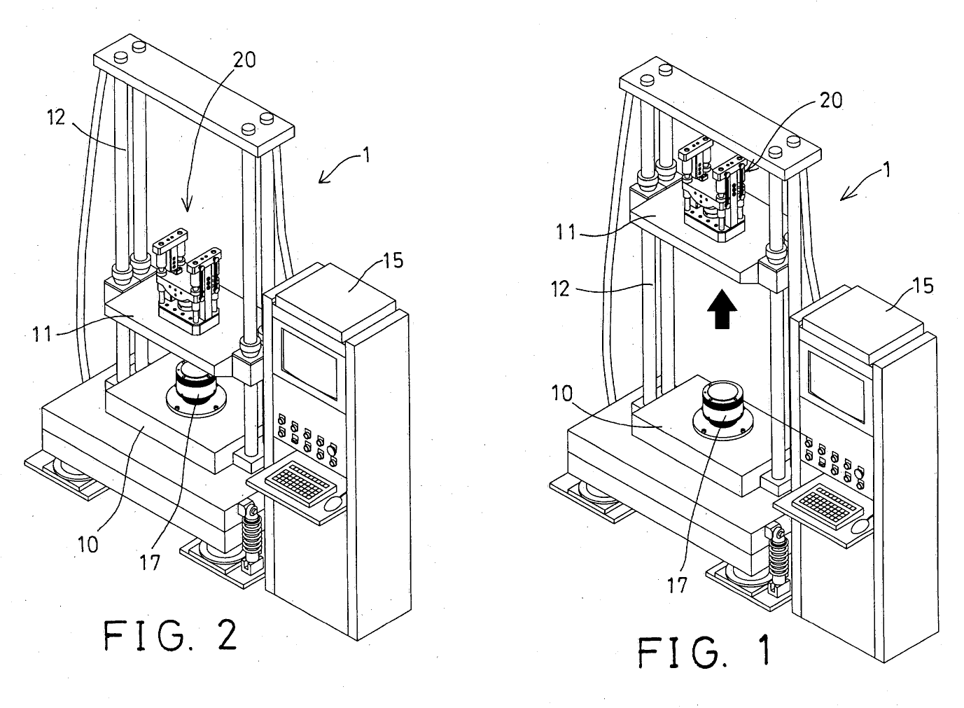

Referring to the drawings, and initially to FIGS. 1 and 2, illustrated is an impact tester or impact testing machine 1 which comprises a slidable table 11 slidably supported above a platform 10 by one or more posts 12, and movable downwardly toward the platform 10, for testing purposes. For example, the slidable table 11 may be used to support the materials or objects to be tested, or to support an impact generating device 20 in accordance with the present invention that may be used to support materials or objects of different weights.

The impact tester or impact testing machine 1 may further comprises a computerized sensing or detecting device 15 to detect the striking or impact or shock waves generated by the impact of the slidable table 11 against the platform 10. A cushioning device 17 may further be provided and disposed on the platform 10, to cushion the slidable table 11, and to apply a rebound force against the slidable table 11 when the slidable table 11 is impacted or stricken against the platform 10.

The cushioning devices 17 and the computerized sensing or detecting device 15 of the impact tester or impact testing machine 1 are not related to the present invention and will not be described in further details.

The impact generating device 20 in accordance with the present invention is provided for being disposed on the slidable table 11, to generate additional impacts or forces against the slidable table 11 and then against the platform 10.

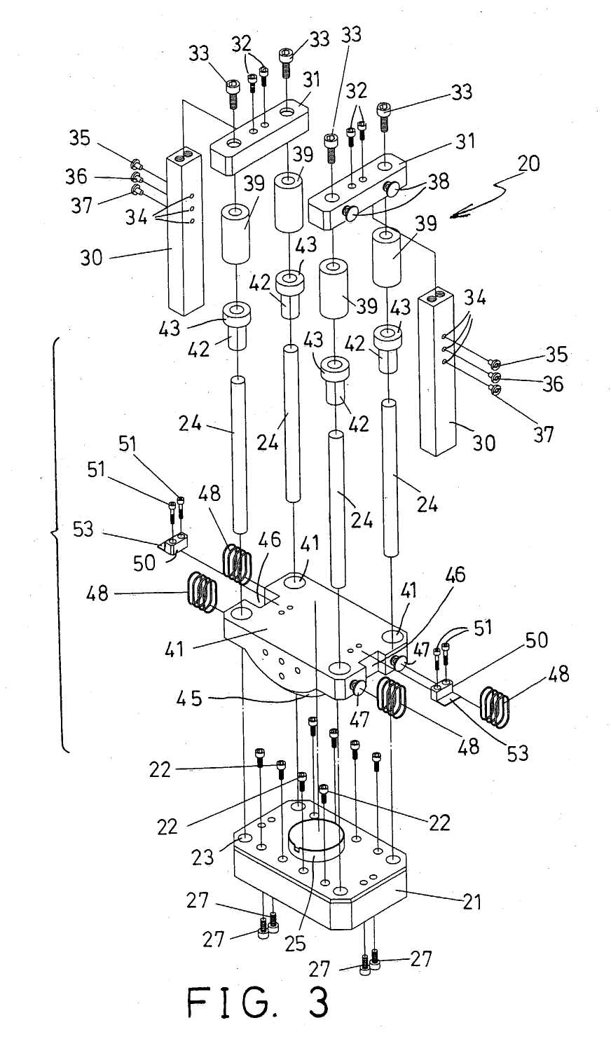

As shown in FIGS. 3-5, the impact generating device 20 comprises a base 21 to be disposed or secured on the slidable table 11 with such as fasteners 22. The base 21 includes one or more, such as four orifices 23 formed therein, such as formed in the four corner areas thereof. One or more, such as four rods 24 have lower ends engaged in the orifices 23 of the base 21, and secured to the base 21 with such as force-fitted engagements, welding processes, or by fasteners or latches (not shown) or the like.

One or more, such as two beams 30 are secured on top of the base 21 with such as fasteners 27, and extended upwardly from the base 21, and one or more, such as two bars 31 are secured on top of the beams 30 and/or the rods 24 with such as fasteners 32, 33, and preferably arranged or extended perpendicular to the beams 30 and/or the rods 24. The beams 30 and the rods 24 may thus be solidly secured between the base 21 and the bars 31. The base 21 preferably includes an anvil swelling 25 provided on top thereof.

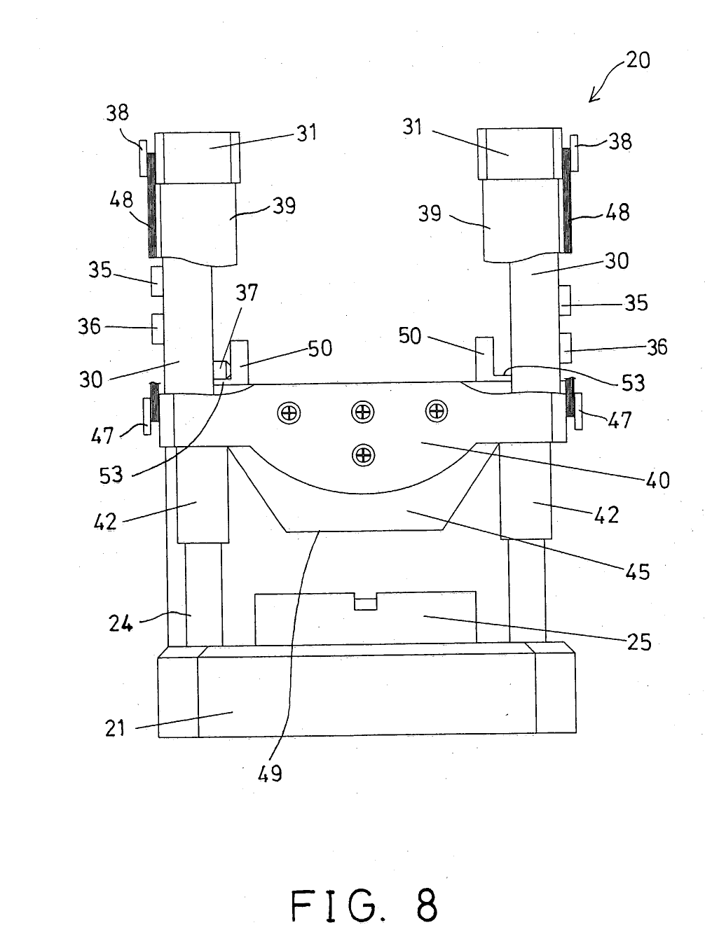

Each of the beams 30 preferably includes one or more apertures 34 formed therein and arranged along the longitudinal direction of the beams 30 respectively, and preferably located in the upper portion of the beams 30 respectively, to slidably receive stop pins 35, 36, 37 therein respectively. The stop pins 35, 36, 37 are selectively depressible or extendible out of the beams 30 respectively by users (FIG. 8).

Each of the bars 31 preferably includes one or more, such as two anchor studs 38 secured thereto. One or more, such as four resilient or cushioning and cylindrical pads 39 are engaged onto the rods 24 respectively, and preferably attached to the bottom of the bars 31 respectively with such as adhesive materials, for cushioning purposes.

A hammer 40 is slidably supported above the base 21. For example, the hammer 40 includes one or more, such as four apertures 41 formed therein, such as formed in the four corner areas thereof, to slidably receive the four rods 24 respectively, and to guide the hammer 40 to move up and down along the rods 24, and relative to the base 21. The pads 39 is disposed between the hammer 40 and the bars 31, and may be used to cushion the hammer 40, or to prevent the hammer 40 from being stricken against the bars 31.

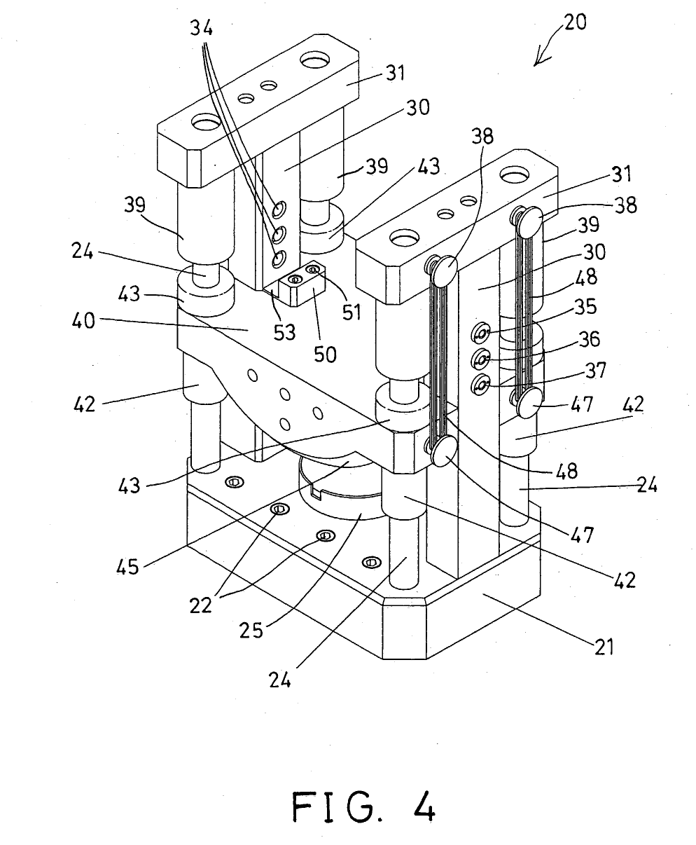

A gasket 42 is preferably engaged between the hammer 40 and each of the rods 24, to allow the hammer 40 to be smoothly moved up and down along the rods 24 respectively. Each of the gaskets 42 preferably includes an enlarged head 43 formed thereon to engage with the hammer 40 (FIGS. 4-7), and to position the gaskets 42 to the hammer 40.

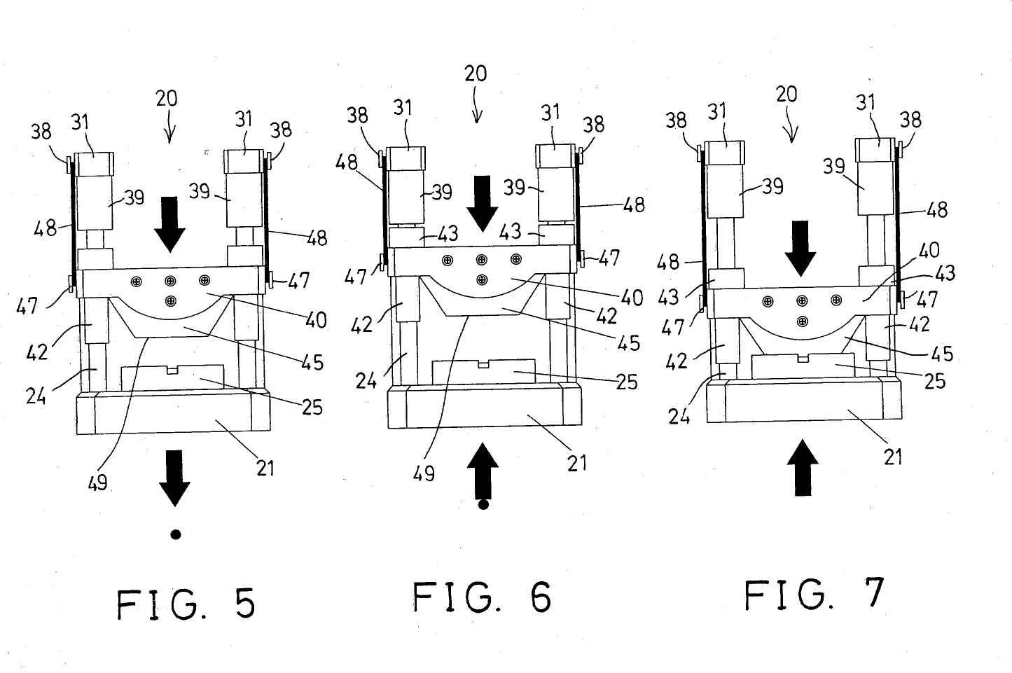

The hammer 40 includes a hammering block 45 extended downwardly therefrom, and preferably includes an inverted and frustum shape, and arranged above the anvil swelling 25, for acting or hammering or impacting onto the anvil swelling 25 (FIGS. 5-7), and for generating impact or striking waves, or shocks or vibrations, or the like.

It is preferable that the hammering block 45 of the hammer 40 includes a narrower bottom portion 49 (FIGS. 5, 6, 8) for engaging or acting or hammering or impacting onto the anvil swelling 25, and for allowing the forces of the hammering block 45 to be applied and concentrated onto the anvil swelling 25, and for generating greater impacts, shocks, vibrations, impact or striking waves, or the like.

The hammer 40 includes one or more, such as two notches 46 formed therein, to slidably receive the beams 30 respectively, and to further smoothly guide the hammer 40 to move up and down along the beams 30 and thus the rods 24, and relative to the base 21. The hammer 40 includes one or more, such as four anchor studs 47 secured thereto, and arranged or disposed below the anchor studs 38 of the bars 31.

One or more resilient members 48, such as rubber bands 48, may further be provided and engaged around the anchor studs 38, 47 of the bars 31 and the hammer 40 respectively, and to resiliently couple the hammer 40 to the bars 31. The hammer 40 may be used to support objects or weights 70, 80 of different weights, and the resilient members 48 may be adjustably coupled between the anchor studs 38, 47 of the bars 31 and the hammer 40 respectively, to support the objects or weights 70, 80 of different weights at suitable distance away from the anvil swelling 25.

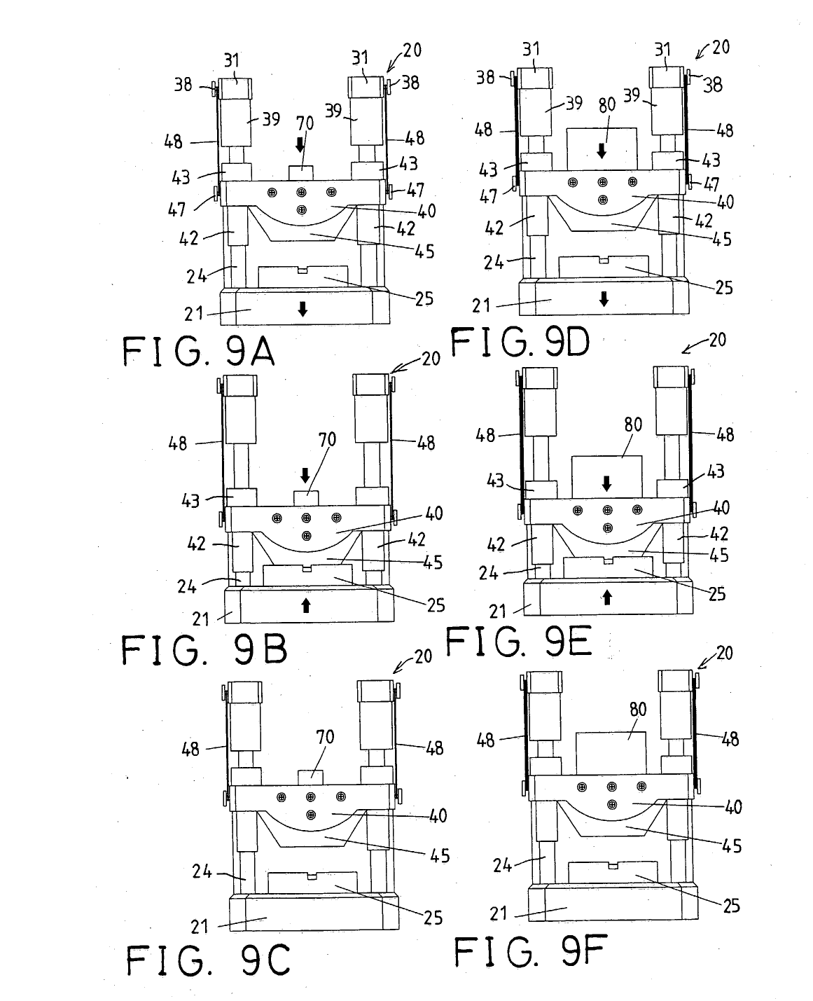

In operation, as shown in FIGS. 9A, 9B, 9C, when a smaller object or weight 70 having a lighter weight is supported above the hammer 40, one or fewer resilient members 48 may be coupled between the anchor studs 38, 47 of the bars 31 and the hammer 40 respectively, to suitably space the hammer 40 and the object or weight 70 away from the anvil swelling 25 or the base 21 for a suitable distance.

As shown in FIGS. 9D, 9E, 9F, when a greater object or weight 80 having a heavier weight is supported above the hammer 40, two or more resilient members 48 may required to be coupled between the anchor studs 38, 47 of the bars 31 and the hammer 40 respectively, to suitably space the hammer 40 and the heavier object or weight 80 away from the anvil swelling 25 for a suitable distance, and thus for allowing the hammer 40 to be suitably impacted onto the base 21 when heavier objects or weights 80 are supported on the hammer 40.

As shown in FIGS. 3, 4, and 8, one or more, such as two seats 50 are secured on the hammer 40 with such as fasteners 51, and arranged or disposed beside the beams 30 or the notches 46 of the hammer 40 respectively, and each includes a flap 53 extended therefrom, and extended toward the beams 30 or the notches 46 of the hammer 40 respectively, to engage with the stop pins 35, 36, 37 of the beams 30 (FIG. 8), and to determine the spaced distance between the hammer 40 and the base 21.

For example, when the higher stop pin 35 of the beam 30 is engaged with the flap 53 of the seat 50, or directly engaged with the hammer 40, the hammer 40 may be spaced from the base 21 for a greater distance, and may thus be moved for a farther distance downwardly toward or against the base 21, in order to generate a greater impact or striking.

On the contrary, when the lower stop pin 37 of the beam 30 is engaged with the flap 53 of the seat 50, or directly engaged with the hammer 40, the hammer 40 may be spaced from the base 21 for a less distance, and may thus be moved for a decreased distance downwardly toward or against the base 21, in order to generate a smaller impact or striking.

As best shown in FIG. 8, it is preferable that the stop pins 35, 36, 37 of the beams 30 are arranged in different height relative to the base 21, in order to increase the selections of the heights of the hammer 40 relative to the base 21. For example, the six stop pins 35, 36, 37 of the beams 30 may be used to space the hammer 40 from the base 21 at six different heights or spacing distances.

In operation, as shown in FIGS. 1, 2, when the slidable table 11 is moved downwardly toward or to act or to impact onto the platform 10 or the cushioning device 17, the hammer 40 (FIGS. 5-7) and/or the objects or weights 70, 80 (FIGS. 9A-9F) may then be forced or actuated to move downward toward the base 21, and to strike or impact onto the base 21 once the slidable table 11 impacts onto the platform 10 or the cushioning device 17, in order to generate impacts, shocks, vibrations, or the like.

The computerized sensing or detecting device 15 may then be used to detect the striking or impact or shock or striking waves generated by the impact of the slidable table 11 against the platform 10, and/or the striking or impact of the hammer 40 onto the base 21.

Accordingly, the adjustable impact generating device in accordance with the present invention may be used for generating striking forces or impacts against the slidable table and/or against the platform.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An impact generating device for an impact testing machine, said impact generating device comprising:
a base to be supported in the impact testing machine,
a hammer slidably supported above said base, and movable downwardly toward said base, for striking or impacting onto said base, and
resiliently and adjustably supporting means for resiliently and adjustably supporting said hammer above said base, to adjustably space said hammer from said base at selected spacing distances, and to adjustably determine a moving distance of said hammer toward said base.

2. The impact generating device as claimed in claim 1 further comprising at least one rod secured to said base, and extended upwardly from said base, said hammer including an apertures formed therein to slidably receive said at least one rod, and to guide said hammer to move up and down relative to said base.

3. The impact generating device as claimed in claim 2 further comprising a gasket engaged between said hammer and said at least one rod, and to smoothly guide said hammer to move along said at least one rod.

4. The impact generating device as claimed in claim 3, wherein said gasket includes an enlarged head engaged with said hammer, to position said gasket relative to said hammer.

5. The impact generating device as claimed in claim 2, wherein said resiliently and adjustably supporting means includes a bar secured on said at least one rod, a first resilient member coupled between said hammer and said bar, and at least one second resilient member selectively coupled between said hammer and said bar.

6. The impact generating device as claimed in claim 5, wherein said bar includes a stop pin secured thereto, said hammer includes a stop pin secured thereto, said first and said at least one second resilient members are selectively coupled around said stop pins of said bar and said hammer, to resiliently couple said hammer to said bar.

7. The impact generating device as claimed in claim 5, wherein said at least one rod includes a pad engaged thereon and disposed between said hammer and said bar, to prevent said hammer from striking onto said bar.

8. The impact generating device as claimed in claim 1, wherein said base includes an anvil swelling provided thereon, said hammer includes a hammering block extended downwardly therefrom, and arranged above said anvil swelling, to act and impact onto said anvil swelling.

9. The impact generating device as claimed in claim 8, wherein said hammering block of said hammer includes an inverted and frustum shape.

10. The impact generating device as claimed in claim 1 further comprising spacing distance determining means for determining the spacing distance of said hammer from said base.

11. The impact generating device as claimed in claim 10, wherein said spacing distance determining means includes a beam secured to said base, and extended upwardly from said base, and a first stop pin slidably engaged in said beam, and extendible out of said beam to selectively engage with said hammer, and to determine the spacing distance of said hammer from said base.

12. The impact generating device as claimed in claim 11, wherein said spacing distance determining means further includes at least one second stop pin slidably engaged in said beam, and selectively extendible out of said beam to selectively engage with said hammer, and to selectively adjust the spacing distance of said hammer from said base.

13. The impact generating device as claimed in claim 12 further comprising a flap disposed on said hammer to selectively engage with said first stop pin and said at least one second stop pin.

14. The impact generating device as claimed in claim 13, wherein said hammer includes a seat secured thereon, and having said flap extended from said seat.
